(19) United States
(12) Patent Application Publication
(10) Pub. No.: US 2015/0077885 A1
(43) Pub. Date: Mar. 19, 2015

(54) TEMPERATURE PROTECTION DEVICE AND CIRCUIT ARRANGEMENT

(71) Applicant: Brose Fahrzeugteile Gmbh & Co.KG, Wuerzburg, Wuerzburg (DE)

(72) Inventor: Uwe Hartmann, Wenkheim (DE)

(21) Appl. No.: 14/386,059

(22) PCT Filed: Mar. 19, 2013
(86) PCT No.: PCT/EP2013/000826

§ 371 Date: Sep. 18, 2014

(30) Foreign Application Priority Data
Mar. 19, 2012 (DE) 20 2012 002 820.0

(51) Int. Cl. H01H 37/46; H02H 7/085

(52) U.S. Cl. CPC H01H 37/46; H02H 7/0852; H01H 2201/026
USPC 361/25; 337/393

(57) ABSTRACT

Temperature protection device for use in an electrical power circuit for protecting said electrical power circuit against heating, comprising a first contact element and a second contact element, which are connected to one another by the ends thereof, and are designed in such a way that the ends of said first and said second contact elements that are connected to one another separate from one another when a limit temperature is exceeded because of a mechanical pretension between the two ends, thereby interrupting the electrical circuit, wherein at least the ends of the contact elements have a material with a higher recrystallization temperature than pure copper.

### CROSS-REFERENCE TO RELATED APPLICATION

This Application is a Section 371 National Stage Application of International Application No. PCT/EP2013/000826, filed 19 Mar. 2013 and published as WO 2013/139466 A1 on 26 Sep. 2013, in German, the contents of which are hereby incorporated by reference in their entirety.

### FIELD OF THE INVENTION

The present invention relates to a thermal protection device for use in an electric circuit for protecting the electric circuit against heating. The present invention also relates to a circuit arrangement.

### TECHNICAL BACKGROUND OF THE INVENTION

The present invention relates to a thermal protection device for use in an electric circuit of an electrical apparatus, in particular an expendable thermal protection device for use in electric motors in the field of motor vehicles.

For many electric motors used in the field of motor vehicles, a thermal protection device, which is also referred to in the following as a thermal protector for the sake of simplicity, is used on the basis of what are known as soldered chokes. Electric motors of this type may for example be cooling fan motors or motors for an air-conditioning system. Said soldered chokes essentially have the function of an interference-eliminating choke which is known to a person skilled in the art. In interference-eliminating chokes of this type, voltage spikes, which occur in an undesired manner and could damage electronic components in the motor, are largely prevented.

Conventionally, said chokes are substantially in the form of a coil spring consisting of wire material, that is to say one or more wire portions, the wire material breaking at a point which is generally in the centre of the coil spring based on the longitudinal orientation, and the ends of the wire portions, which are also generally referred to in this application as contact means connected in series, are soldered using a solder material while being biased against one another. The chokes are arranged in an electric circuit of an electric motor and have both the function of eliminating interference in the electric circuit and the function of protecting the electronic components against undesired temperature increases, for example due to an excessively high flow of current or an excessively high ambient temperature.

If a determined limit temperature is reached, the solder material which is electrically interconnecting the two wire-portion ends melts. Owing to the mechanical bias prevailing between the two wire-portion ends, the two previously soldered wire-portion ends spring apart and the electric circuit is broken. Since the electric circuit, which is now mechanically separated, naturally cannot close again by itself, this is also referred to as an expendable thermal protector.

The thermal protector considered within the context of this invention is used primarily to prevent fire. Accordingly, in the thermal protector according to the invention, a higher limit temperature has to be used than in conventional devices for limiting temperature, which for example are only used for protecting electronic components. Said higher limit temperature, of in particular greater than 120° C., may not however be reached by a mechanically biased choke made of substantially pure copper. This is the case because pure copper material already begins to recrystallise from a temperature of 120° C., and thus the mechanical bias is lost.

When observed over a relatively long period of time, which ideally approximately corresponds to the service life of the motor in which said thermal protector is installed, the choke functions as a thermal protector up to a determined temperature limit, which is dependent on the wire material. If this temperature limit is however exceeded over a certain period of time, the reliability of the component, that is to say the choke, reduces in terms of its thermal protection function. This is because recrystallisation then takes place in the wire material, which triggers a thermally induced mechanical release of the material, which is usually a copper material. This release disadvantageously reduces the mechanical bias of the two wire-portion ends at the solder point in an irreversible manner, and in some circumstances can therefore no longer sufficiently electrically separate the solder point, even after the solder material has melted, since the wire-portion ends no longer have the required mechanical bias.

With the introduction of the Europe-wide ban, which only came into force recently, on the use of solder materials which contain lead, in conjunction with the increased use of silver-containing solder materials having a relatively high melting temperature which is produced owing to the properties of the silver, the soldered choke or the wire material is also subjected to relatively high temperatures until the solder material melts, and this disadvantageously accelerates the thermally induced mechanical release of the copper material, so that the choke can then no longer be reliably used as a thermal protector.

For the sake of completeness, it should be mentioned that the choke may contain at least one choke core in the cavity therein formed by the spiral windings, in order to intensify the electromagnetic field arising owing to the shape of the coil and thus to intensify the function of eliminating interference. The choke core does not, however, have an effect on the function as a thermal protector.

### SUMMARY OF THE INVENTION

The problem addressed by the present invention is that of providing an improved thermal protector for an electric circuit.

The following is accordingly provided:
A thermal protection device for use in an electric circuit for protecting the electric circuit against heating, comprising a first contact element and a second contact element, which are interconnected via respective ends and are formed such that, when a limit temperature is exceeded, the respective interconnected ends of the first and second contact elements separate from each other owing to a mechanical bias between the two ends, and the electric circuit is thus broken, wherein at least the ends of the contact elements comprise a material having a recrystallisation temperature that is higher than pure copper.
A circuit arrangement, comprising an electric circuit and comprising a thermal protection device according to the invention, which is arranged in series in a current path of the electric circuit.

The understanding forming the basis for the present invention consists in using an alternative base material for the choke, that is to say for the wire material, which has an increased recrystallisation temperature. This is achieved by adding small amounts of other metals to the pure copper by alloying, thereby producing a low-alloy copper material. Low-alloy copper materials of this type increase the recrystallisation temperature, so that it is also possible, using a base material of this type, to use soldered chokes having solder which has a relatively high melting point, such as silver-containing solder, in a functionally reliable manner at high temperatures.

In addition, there is the advantage that increased ambient temperatures for the component, that is to say the choke, or for the motor in which the choke is installed, are possible.

Advantageous embodiments and developments emerge from the additional dependent claims and from the description with reference to the figures of the drawings.

For example, the respective ends of the first contact element and the second contact element may be electrically and mechanically interconnected by a solder material.

In a first configuration, all the contact elements comprise a material having a recrystallisation temperature that is higher than that of pure copper.

In further configurations, the wire portions respectively comprise one of the following materials: copper alloys, low-alloy copper, low-alloy copper having silver as an alloying constituent, copper alloy having a silver content of 0.1%. Copper alloys having a different silver content are of course also possible. The materials in the various configurations differ in this case with respect to their electrical conductivity, so that the material can be selected depending on the desired use. If high conductivity is required, copper alloys having primarily low-alloy copper are advantageous. Copper which is primarily alloyed with silver is in the same conductivity range as pure silver and is therefore advantageous, since the temperature load capacity is also relatively high owing to the silver.

In a possible configuration, the first contact element and/or the second contact element are each formed as wire portions, which are formed as choke windings in the manner of a coil. For example, at least one choke core may be arranged in the wire portions which are formed as choke windings.

In a further preferred configuration, the ends are formed as portions projecting from the coil which extend substantially in parallel, so that it is easier to attach the ends to one another.

In a further configuration, one or both of the contact elements which are electrically coupled to each other and/or the ends of said contact elements are each in the form of a leaf spring.

In a further configuration, the electric circuit contains an electric machine, for example an electric motor for a motor vehicle. The current-carrying load path of the electric machine is for example arranged in series with the current path of the electric circuit and the thermal protection device.

The above embodiments and developments can be combined in any conceivable manner, as long as this is reasonable. Further possible configurations, developments and uses of the invention also include combinations of features of the invention, in particular of materials, described previously or below with respect to the embodiments, even if not explicitly stated. In this case, a person skilled in the art will more particularly also add individual aspects as improvements or additions to the respective basic forms of the present invention.

### BRIEF DESCRIPTION OF THE DRAWINGS

The present invention is explained below in greater detail on the basis of embodiments specified in the schematic figures in the drawings, in which:

FIG. 1 is a side view of a choke according to an embodiment of the invention; and

FIG. 2 is a three-dimensional view of the choke from FIG. 1.

The accompanying drawings are intended to convey further understanding of the embodiments of the invention. They show embodiments and, in conjunction with the description, clarify the principles and concepts behind the invention. Other embodiments and many of the advantages mentioned are apparent with reference to the drawings. The elements of the drawings are not necessarily shown to scale.

In the figures of the drawings, the same elements, features and components, or those serving the same function and having the same effect, are provided with the same reference numerals in each case, unless specified otherwise.

### DETAILED DESCRIPTION OF EMBODIMENTS

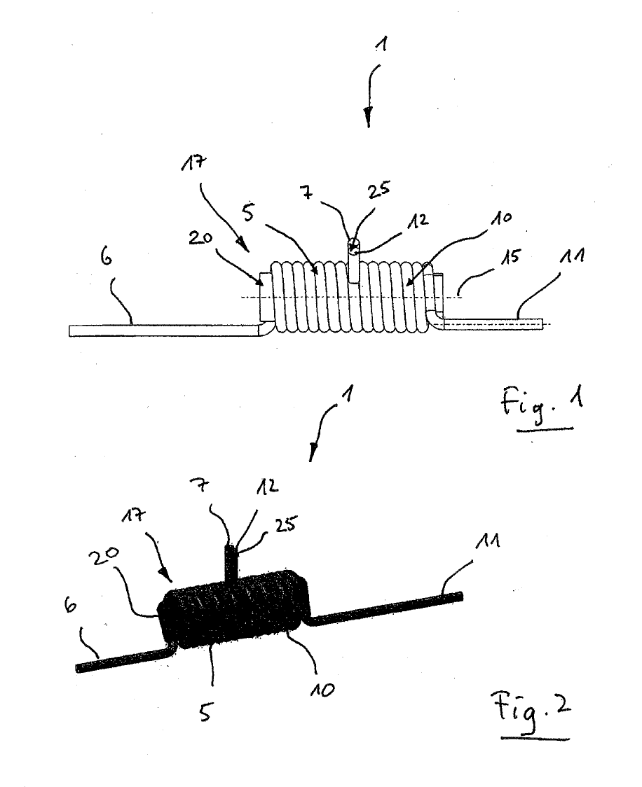

FIG. 1 shows a thermal protector formed as a choke coil or choke 1. The choke 1 comprises a first contact means 5 and a second contact means 10. In the example shown in FIG. 1, the contact means 5, 10 are shown as wire portions which are each shaped into coils in a helical manner.

The contact means or wire portions 5 and 10 have an end 6 and 11 respectively which points away from the coil (referred to in the following as a second end in each case) and is coupled to connections (not shown here) of an electric circuit.

Furthermore, the wire portions 5 and 10 have an end 7 and 12 respectively (referred to in the following as a first end in each case) which extends approximately in the centre, based on the longitudinal orientation (shown by a dashed central line 15 in FIG. 1) of the choke 1, away from the choke 1 (in the example shown, upwards based on FIG. 1). The ends 7 and 12 rest against each other, and are indeed mechanically biased against each other, the ends 7 and 12 having the tendency to move away from each other in opposite directions.

The ends 7, 12 are now both electrically and mechanically coupled to each other at a solder point 25 by a solder material (not shown in FIG. 1) between the ends 7, 12. The manner in which the ends 7, 12 are soldered to each other shall not be elaborated upon, since this is generally known. Other types of connection between the ends 7, 12 which serve the purpose within the meaning of the invention are also conceivable.

If the temperature now increases at the solder point 25, whether owing to an increased flow of current through the choke 1 or owing to an increased ambient temperature, then the solder material between the ends 7, 12 melts, and the ends 7, 12 move away from each other owing the mechanical bias between said ends 7, 12, so that the flow of current through the choke 1 is interrupted.

For the sake of completeness, it is also noted that the wire portions 5, 10 generally comprise an outer insulating layer, but the ends 7, 12 for producing the electrical contact therebetween are bare. It is thus ensured that when the solder point 25 springs open, the current cannot continue to flow through adjacent choke windings.

In order to prevent the material of the wire portions 5, 10 from recrystallising owing to ongoing heating above a certain temperature which is dependent on the material, which would, as already indicated above, lead to a thermally induced mechanical release of the material of the wire portions 5, 10, the wire portions 5, 10 consist of one of the following materials: copper alloys, low-alloy copper, low-alloy copper having silver as an alloying constituent or a copper alloy having a preferred silver content of 0.1%, a different silver content also being conceivable, or a material having a recrystallisation temperature that is higher than pure copper. Using a wire-portion material of this type, it is also possible to produce solder points using solder which has a relatively high melting point, such as silver-containing solder, in a functionally reliable manner.

Although it is not explicitly shown, the contact elements 5, 10 and/or the ends thereof which are to be interconnected can each also be in the form of a leaf spring, the contact elements each consisting of one or more of the above-stated materials. A solder point between corresponding ends of the contact elements is produced in a similar manner to that which is explained above.

For better understanding, FIG. 2 shows the choke 1 from FIG. 1, but in a three-dimensional view, there not being any differences in respect of the construction of the choke 1 from FIG. 1.

The views in FIGS. 1 and 2 are given by way of example and are not to scale, so that the views in FIGS. 1 and 2 should not be taken as limiting in terms of the relative dimensions and measurements.

Although the present invention has been fully described above by means of preferred embodiments, it is not limited to the above, but may be modified in a number of ways.

The invention is thus not only applicable in the field of motor vehicles, but can also be advantageously used in any desired field of application in which an expendable thermal protector is required for an electrical apparatus.

1-11. (canceled)

12. A thermal protection device for use in an electric circuit for protecting the electric circuit against heating, comprising a first contact element and a second contact element, which are interconnected via respective ends and are formed such that, when a limit temperature is exceeded, the respective interconnected ends of the first and second contact elements separate from each other owing to a mechanical bias between the two ends, and the electric circuit is thus broken, wherein at least the ends of the contact elements comprise a material having a recrystallisation temperature that is higher than pure copper.

13. The thermal protection device according to claim 12, wherein the respective ends of the first contact element and the second contact element are electrically and mechanically interconnected by a solder material.

14. The thermal protection device according to claim 12, wherein all the contact elements comprise a material having a recrystallisation temperature that is higher than pure copper.

15. The thermal protection device according to claim 12, wherein the contact elements consist of a low-alloy copper, in particular of a low-alloy copper having silver as an alloying constituent.

16. The thermal protection device according to claim 15, wherein the contact elements consist of a copper alloy, in particular of a copper alloy having a silver content of 0.1%.

17. The thermal protection device according to claim 12, wherein the first contact element and/or the second contact element are each formed as wire portions, which are formed as choke windings in the manner of a coil.

18. The thermal protection device according to claim 17, wherein at least one choke core is arranged in the wire portions which are formed as choke windings.

19. The thermal protection device according to claim 17, wherein the ends are formed as portions projecting from the coil which extend substantially in parallel.

20. The thermal protection device according to claim 12, wherein one or both of the contact elements which are electrically coupled to each other and/or the first ends of said contact elements are each in the form of a leaf spring.

21. A circuit arrangement, comprising an electric circuit and comprising a thermal protection device, with the thermal protection device including a first contact element and a second contact element, which are interconnected via respective ends and are formed such that, when a limit temperature is exceeded, the respective interconnected ends of the first and second contact elements separate from each other owing to a mechanical bias between the two ends, and the electric circuit is thus broken, wherein at least the ends of the contact elements comprise a material having a recrystallisation temperature that is higher than pure copper, wherein the thermal protection device is arranged in series in a current path of the electric circuit.

22. The circuit arrangement according to claim 21, wherein the electric circuit comprises an electric machine, in particular an electric motor for a motor vehicle, of which the current-carrying load path is arranged in series with the current path of the electric circuit and the thermal protection device.
